(19) United States
(12) Patent Application Publication
(10) Pub. No.: US 2007/0071934 A1
(43) Pub. Date: Mar. 29, 2007

(54) Unit of continuous and perforated gift paper

(76) Inventor: Ann A. Lowney, Davisburg, MI (US)

Correspondence Address: HARNESS, DICKEY & PIERCE, P.L.C., P.O. BOX 828, BLOOMFIELD HILLS, MI, 48303, US

(21) Appl. No.: 11/239,563

(22) Filed: Sep. 29, 2005

(51) Int. Cl. G09F 3/00

(52) U.S. Cl. 428/43

(57) ABSTRACT

A unit of gift paper that includes a continuous sheet of paper and at least one perforation disposed on the sheet of paper. The perforation is adapted for separating the sheet of paper into separate pieces of paper that can be arranged with the package. The sheet of paper is wound about an axis so as to form a roll of paper having a plurality of layers of pieces of paper lying directly over each other. A method of preparing a package and a method of manufacturing a unit of gift paper is also disclosed.

### FIELD OF THE INVENTION

The present invention relates to gift paper and, more particularly, to a unit of continuous and perforated gift paper.

### BACKGROUND OF THE INVENTION

It is known to prepare gifts and packages with paper. Tissue paper, for instance, is used because it is lightweight, which allows the tissue paper to be readily stuffed into boxes or wrapped around items, such as dry-cleaned clothing. Tissue paper can also be decorated with various colors and designs to make the package more aesthetically pleasing.

However, conventional paper suffers from certain disadvantages. For instance, tissue paper is typically sold in packages of several sheets that are stacked, folded, and contained within a bag. The bag of paper can be bulky, which is undesirable when storing the paper. Also, to use the tissue paper, the bag is opened, the stack is removed from the bag, the stack is unfolded, and a single sheet is separated from the stack. The sheet may also need to be cut down to a usable size. This process can be inconvenient and time consuming. Also, unused sheets from the stack of tissue paper may become damaged before they can be placed back into the bag. Furthermore, unused sheets can be difficult to re-stack, re-fold, and replace back into the bag.

Therefore, there remains a need for a unit of paper that is more compact. There also remains a need for a unit of paper that is conveniently dispensed such that the paper can be used more easily and neatly. Furthermore, there remains a need for a unit of paper from which a portion can be removed without damaging unused portions of the tissue paper. Still further, there remains a need for a unit of paper that facilitates clean up of unused sheets of paper.

### SUMMARY OF THE INVENTION

The disadvantages of the prior art are overcome with the unit of gift paper for a package of the present invention. The unit of gift paper includes a continuous sheet of paper and at least one perforation disposed on the sheet of paper. The perforation is adapted for separating the sheet of paper into separate pieces of paper that can be arranged with the package. The sheet of paper is wound about an axis so as to form a roll of paper having a plurality of layers of pieces of paper lying directly over each other.

In another aspect, the present invention is a method of preparing a package that includes obtaining a unit of gift paper that includes a continuous sheet of paper and at least one perforation disposed on the sheet of paper. The sheet of paper is wound about an axis so as to form a roll of paper having a plurality of layers of pieces of paper lying directly over each other. The method also includes tearing at least one piece of paper from the continuous sheet of paper along the at least one perforation. The method further includes arranging the at least one piece of paper with the package.

In still another aspect, the present invention is a method of manufacturing a unit of gift paper that includes obtaining a continuous sheet of paper, perforating the continuous sheet of paper, and winding the sheet of paper about an axis so as to form a roll of paper having a plurality of layers paper lying directly over each other.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a unit of gift paper constructed according to the teachings of the present invention; and

FIG. 2 is a perspective view of the unit of gift paper including a container.

### DETAILED DESCRIPTION OF THE PREFERRED EMBODIMENTS

The following description of the preferred embodiment(s) is merely exemplary in nature and is in no way intended to limit the invention, its application, or uses.

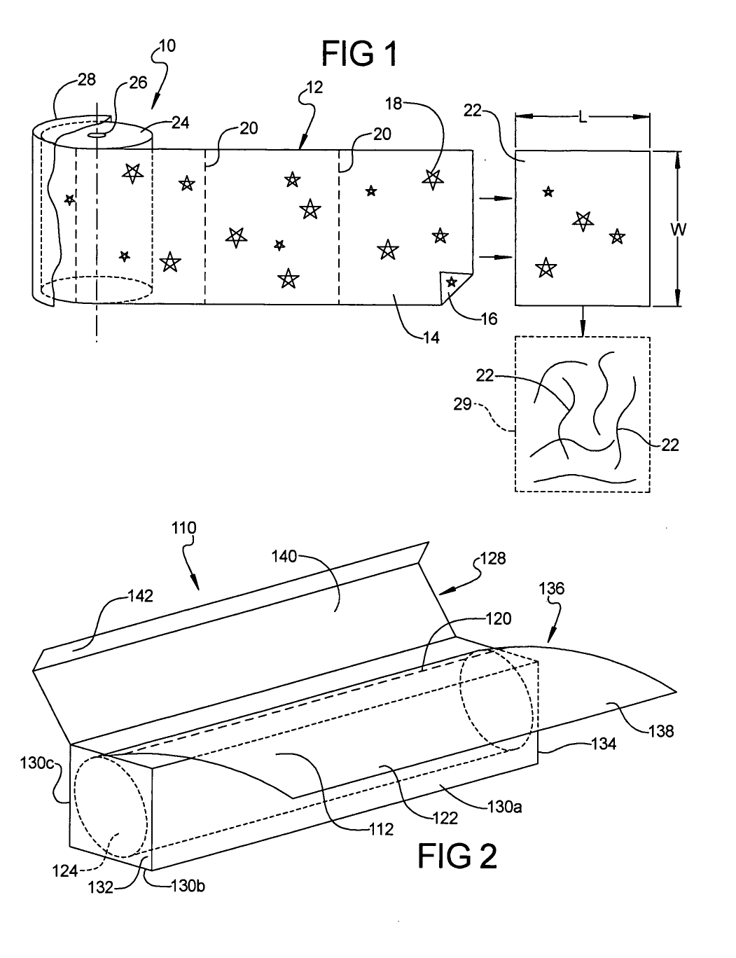

Referring to FIG. 1, one embodiment of a unit of gift paper is generally indicated at 10. The unit of paper 10 generally includes a continuous sheet of paper 12. The sheet 12 defines a first side 14 and a second side 16. The sheet 12 can be of any suitable shape. For instance, in the embodiment shown, the sheet 12 is rectangular and elongate in one direction.

The sheet 12 can be made out of any suitable type of paper. In one embodiment, the sheet 12 is made out of tissue paper. The tissue paper is generally lightweight and can be easily crumpled. For instance, in one embodiment the sheet 12 of tissue paper weighs less than approximately forty (40) grams per square meter. Also, in one embodiment, the sheet 12 of tissue paper is single-ply tissue paper. The sheet 12 of tissue paper can also be of any suitable texture. For instance, in one embodiment, the sheet 12 of tissue paper is crinkled to form crepe paper that is stretchable and that is relatively soft.

In the embodiment shown, the sheet 12 of tissue paper also includes at least one, and preferably a plurality of decorative elements 18. More specifically, the first side 14 and the second side 16 of the sheet 12 of tissue paper are printed with decorative elements 18, namely, stars in the embodiment shown. The sheet 12 could include other decorative elements 18, such as a solid color that encompasses the entire sheet 12. Other decorative elements 18 or indicia could include a combination of colors that spans the sheet 12. Still other decorative elements 18 could include any suitable pattern that is embossed on the sheet 12. The decorative elements 18 could be included on the sheet 12 in any suitable manner, such as dyeing, printing and the like. It should be appreciated that the decorative elements 18 provide aesthetic appeal to the unit of paper 10. For instance, during the Christmas season, the unit of paper 10 could include a red background embossed with a plurality of stars, and the unit of paper 10 could be used in preparing a package indicative of the festive holiday.

The unit of paper 10 also includes at one and, preferably, a plurality of perforations 20. Each perforation 20 includes a plurality of aligned apertures extending across the sheet 12 of tissue paper. In one embodiment, the unit of paper 10 includes a plurality of perforations 20 each disposed in spaced relationship to one another along the length of the sheet 12. Also in one embodiment, the perforations 20 are equally spaced from one another. The perforations 20 are each adapted for separating the sheet 12 of tissue paper into separate pieces of tissue paper 22.

When separated from the sheet 12 of tissue paper, the pieces 22 of tissue paper can be of any suitable size. For instance, the piece 22 defines a width dimension (W) that is approximately parallel to the perforation 20, and the piece 22 also defines a length dimension (L) that is approximately perpendicular to the perforation 20. The piece 22 can be of any suitable size. For instance, in one embodiment, the length (L) of each piece 22 of the tissue paper is between approximately six (6) and ten (10) inches. Also, in one embodiment, the width (W) of each piece 22 is between approximately six (6) and ten (10) inches. Furthermore, in one embodiment, each of the pieces 22 are approximately square. For instance, in one embodiment, each piece 22 is eight (8) inches in length (L) and eight (8) inches in width (W). The pieces 22 are preferably of a useful and practical size. It should be appreciated that the perforations 20 formed in the sheet 12 allow a user to manually separate the sheet 12 into separate pieces 22. This allows the user to obtain a piece 22 of tissue paper without the use of scissors, knives, or other tools.

Once separated, the piece 22 can be arranged within a package 29 (shown in phantom) as shown in FIG. 1. The paper can be stuffed within the package 29. For instance, the paper can be crumpled and placed within a box to create an aesthetically pleasing package 29. Other packages 29 could include clothing or other objects around which the piece 22 of tissue paper is wrapped.

In the embodiment shown, the sheet 12 of tissue paper is wound about an axis (X) so as to form a roll 24 of tissue paper. For instance, in one embodiment, the unit of paper 10 also includes a core 26, such as a cardboard tube, about which the sheet 12 of tissue paper is wound so as to form the roll 24 of tissue paper. In the preferred embodiment, the sheet 12 is wound in the roll 24 to form a plurality of layers of pieces 22 lying directly over each other with nothing lying between the layers such that the roll 24 is more compact. The unit 10 of paper can be manufactured by obtaining a continuous sheet of tissue paper 12 and perforating the continuous sheet of tissue paper in any suitable manner. The sheet 12 can then be rolled about the axis (X) about the core 26 to create the roll 24. It should be appreciated that the roll 24 provides a convenient means for dispensing and storing unused portions of the sheet 12 of tissue paper.

The unit of paper 10 also includes a container 28 into which the continuous sheet 12 of tissue paper is disposed. In the embodiment show in FIG. 1, the container 28 is a flexible wrap that is wrapped around the roll 24. In one embodiment, the container 28 shown in FIG. 1 is a plastic film that is disposed around the roll 24. In an alternative embodiment shown in FIG. 2, an alternative embodiment of the container is indicated at 128, where like numerals increased by 100 indicate like structure with respect to the embodiment shown in FIG. 1. In the embodiment of FIG. 2, the container 128 includes a plurality of longitudinal sides 130a, 130b, 130c. The container 128 also includes a first end 132 and a second end 134. As such, the longitudinal sides 130a, 130b, 130c and the first and second ends 132, 134 define an opening 136 through which the roll 124 can move into and out of the container 128. A terminal end 138 of the sheet 112 can extend through the opening 136 while the remaining portion of the roll 124 is disposed within the container 128. The container 128 also includes a lid 140. The lid 140 is hingedly attached to one of the longitudinal sides 130c. The lid 140 can cover the opening 136 to close the container 128. The lid 140 can also be pivoted to open the opening 136 for dispensing of the sheet 12 of tissue paper. The container 128 also includes a flap 142 which is fixed to the lid 140 on a side opposite to the longitudinal side 130c.

When using the unit of tissue paper 110 of FIG. 2, the user opens the lid 140 and pulls the terminal end 138 through and away from the opening 136 of the container 128. The user then secures the roll 124 and continues pulling the terminal end 138 until a piece 122 of tissue paper separates from the roll 124 along the perforation 120. It should be appreciated that the lid 140 could be used to secure the roll 124 during this process by placing the lid 140 over the opening 136 and pulling the terminal end 138 until the piece 122 of tissue paper separates from the roll 124.

In summary, the unit of paper 10 of the present invention provides a compact, convenient, useful, and tidy means for obtaining tissue paper. More specifically, the pieces 22 of tissue paper are easy to make. A user simply pulls and separates the piece 22 from the remaining portions of the sheets 12 of tissue paper without the need for scissors, knives or other tools. The pieces 22 are also of a useful and practical size for arrangement in the package 29. The unit of paper 10 is also compact because the paper is contained on the roll 24, 124. The unit of paper 10 is also neat and tidy to use because unused portions of the tissue paper are contained within the roll 24, 124. Also, clean-up of the tissue paper is easy because the unused portions of the tissue paper are contained on the roll 24, 124. Furthermore, the unused portions of the tissue paper are unlikely to be damaged because they are contained on the roll 24, 124.

The description of the invention is merely exemplary in nature and, thus, variations that do not depart from the gist of the invention are intended to be within the scope of the invention. Such variations are not to be regarded as a departure from the spirit and scope of the invention.

1. A unit of gift paper for a package comprising:
a continuous sheet of paper, said sheet of paper is tissue paper that weighs less than approximately forty (40) grams per square meter, said sheet of paper is single-ply paper, and said continuous sheet of paper includes a first side and a second side, and said first side and said second side includes a decorative element; and
at least one perforation disposed on said sheet of paper, said at least one perforation adapted for separating said sheet of paper into separate pieces of paper that can be arranged with the package;
wherein the continuous sheet of paper is wound about an axis so as to form a roll of paper having a plurality of layers of pieces of paper lying directly over each other.

2. (canceled)

3. (canceled)

4. (canceled)

5. The unit of paper of claim 1, wherein said separate pieces of paper are each between approximately six (6) and ten (10) inches in a width dimension that is approximately parallel to said at least one perforation.

6. The unit of paper of claim 1, wherein said separate pieces of paper are each between approximately six (6) and ten (10) inches in a length dimension that is approximately perpendicular to said at least one perforation.

7. The unit of paper of claim 1, wherein said separate pieces of paper are each approximately square.

8. The unit of paper of claim 1, further comprising a container, said continuous sheet of paper is disposed inside said container.

9. The unit of paper of claim 8, wherein said continuous sheet of paper defines a terminal end, and wherein said container includes an opening through which said terminal end can extend.

10. A method of preparing a package comprising the steps of:
obtaining a unit of gift paper that includes a continuous sheet of paper and at least one perforation disposed on the sheet of paper, wherein the sheet of paper is wound about an axis so as to form a roll of paper having a plurality of layers of pieces of paper lying directly over each other;
tearing at least one piece of paper from the continuous sheet of paper along the at least one perforation;
arranging the at least one piece of paper with the package.

11. The method of preparing the package as set forth in claim 10, further comprising the step of obtaining a continuous sheet of tissue paper that weighs less than approximately forty (40) grams per square meter.

12. The method of preparing the package as set forth in claim 10, further comprising the step of obtaining a continuous sheet of single-ply paper.

13. The method of preparing the package as set forth in claim 10, wherein the continuous sheet of paper is disposed within a container with an opening through which a terminal end of the continuous sheet of paper can extend, and further comprising the step of pulling the terminal end of the paper through and away from the opening of the container.

14. The method of preparing the package as set forth in claim 10, wherein said step of arranging the at least one piece of paper with the package comprises stuffing the at least one piece of paper within the package.

15. A method of manufacturing a unit of gift paper comprising the step of:
obtaining a continuous sheet of paper;
perforating the continuous sheet of paper; and
winding the sheet of paper about an axis so as to form a roll of paper having a plurality of layers paper lying directly over each other.

16. The method of claim 15, wherein said step of obtaining a continuous sheet of paper comprises obtaining a continuous sheet of tissue paper that weighs less than approximately forty (40) grams per square meter.
